(19) United States
(12) Patent Application Publication
(10) Pub. No.: US 2023/0257890 A1
(43) Pub. Date: Aug. 17, 2023

(54) SYSTEMS AND METHODS FOR MANUFACTURING CARBON BLACK

(71) Applicant: SkyNano LLC, Knoxville, TN (US)

(72) Inventors: Anna E. DOUGLAS, Knoxville, TN (US); Cary L. PINT, Ames, IA (US)

(21) Appl. No.: 18/090,157

(22) Filed: Dec. 28, 2022

Related U.S. Application Data
(63) Continuation of application No. PCT/IB21/59532, filed on Oct. 15, 2021.
(60) Provisional application No. 63/092,263, filed on Oct. 15, 2020.

(51) Int. Cl. C25B 1/135; C25B 9/09; C25B 11/046; C25B 15/08; C09C 1/48

(52) U.S. Cl. CPC C25B 1/135; C25B 9/09; C25B 11/046; C25B 15/083; C09C 1/487; C01P 2004/64; C01P 2004/62; C01P 2004/61

(57) ABSTRACT

The specification discloses methods and apparatus for producing carbon black from CO₂ by way of a reactor having a chamber filled with a molten salt electrolyte. On application of a current through one or more cathodes and one or more anodes affixed to the reactor, dissolved CO₂ within the molten salt electrolyte is converted into carbon black and oxygen gas. The carbon black is collected.

This invention was made with government support under Small Business Innovation Research (SBIR) Award No. 1843794 awarded by the National Science Foundation (NSF) and Small Business Technology Transfer (STTR) Award No. DE-SC0020811 awarded by the Department of Energy (DOE). The Government has certain rights to this invention.

### BACKGROUND

The concentration of carbon dioxide in the atmosphere is now about 405 parts per million, which is the highest concentration in history. Because of the relationship between atmospheric CO₂ and global warming, technologies that capture, store, or convert CO₂ are desirable. However, known processes are not only costly from the perspective of thermodynamic and electrochemical inputs, but they tend to produce materials which have little if any commercial value.

Carbon black is an allotrope of carbon that is conventionally produced by the incomplete combustion of various carbonaceous materials. In such conventional processes, the carbonaceous material is one or more of fluid catalytic cracking (FCC) tar, coal tar, ethylene cracking tar, and similar high molecular weight derivatives of fossil fuels. Carbon black is used as a reinforcing filler in rubber products such as tires and hoses, and it can also be used as a pigment.

There is a need for processes that not only capture and store CO₂ from the atmosphere, but also produce materials with appreciable commercial value. For example, processes that capture and store CO₂ from the atmosphere by forming carbon black would be particularly desirable.

### SUMMARY

In one embodiment, there is a method of making carbon black, the method comprising: immersing an anode and a cathode in a molten carbonate electrolyte that includes dissolved CO₂, applying an electric current having a current density of from about 50 mA/cm² to about 10 A/cm² to the cathode and the anode, and forming the carbon black on the cathode.

In another embodiment, the current density is about 1 A/cm² to about 10 A/cm².

In another embodiment, the cathode comprises a conductive substrate coated with a passivating layer.

In another embodiment, the conductive substrate includes a one or more of metal, a metal oxide, a ceramic, or a carbon material.

In another embodiment, the passivating layer includes one or more of Al₂O3, TiO₂, MgO, TiN, or VN.

In another embodiment, the passivating layer is about 2 nm to about 100 nm thick.

In another embodiment, the passivating layer is about 45 nm to about 55 nm thick.

In another embodiment, the passivating layer is formed by on the surface of the conductive substrate by one or more of atomic layer deposition (ALD), physical vapor deposition (PVD), or electroplating.

In another embodiment, the anode comprises one or more of a metal, a metal oxide, a ceramic, or a carbon material.

The method of embodiment 9, wherein the anode is a metal and the metal is steel.

The method of embodiment 1, wherein the cathode comprises a one or more of a metal, a metal oxide, a ceramic or a carbon material.

The method of embodiment 11, wherein the cathode is a metal and the metal is steel.

In another embodiment, the molten carbonate electrolyte has a temperature of about 400° C. to about 850° C.

In another embodiment, the molten carbonate electrolyte includes one or more of lithium carbonate, sodium carbonate, potassium carbonate, rubidium carbonate, cesium carbonate, francium carbonate, beryllium carbonate, magnesium carbonate, calcium carbonate, strontium carbonate, barium carbonate, or radium carbonate.

In another embodiment, the molten carbonate electrolyte includes one or more of lithium carbonate, sodium carbonate, or potassium carbonate.

In another embodiment, the molten carbonate electrolyte is a eutectic mixture of two or more of lithium carbonate, sodium carbonate, or potassium carbonate.

In another embodiment, there is a further step comprising injecting the CO₂ into the molten carbonate electrolyte.

In another embodiment, the CO₂ is obtained from one or more of air, seawater, exhaust from an industrial process, or exhaust from an internal combustion engine.

In another embodiment, the carbon black has an average particle diameter of about 50 nm to about 100 μm.

In another embodiment, there is a further step comprising collecting the carbon black from the cathode.

In another embodiment, collecting the carbon black includes: immersing the cathode in a fluid, permitting the carbon black to slough from the cathode so that the carbon black falls to the bottom of the reactor, collecting the fluid and the carbon black from the bottom of the reactor, and filtering the fluid, centrifuging the fluid, evaporating the fluid, or applying an electric field to the fluid to separate the carbon black from the fluid.

In another embodiment, collecting the carbon black includes: immersing the cathode in a fluid, sonicating or scraping the cathode to separate the carbon black from the cathode and thereby disperse the carbon black into the fluid, and filtering the fluid, centrifuging the fluid, evaporating the fluid, or applying an electric field to the fluid to separate the carbon black from the fluid.

In one embodiment, there is an apparatus for forming carbon black comprising: a chamber configured to immerse an anode and a cathode in a molten carbonate electrolyte that includes dissolved CO₂; an inlet for providing CO₂ to be dissolved in the molten carbonate electrolyte, at least one electrical connection that is configured to provide an electric current having a current density of about 100 mA/cm² to about 10 A/cm² to the cathode and the anode, and an outlet for collecting the carbon black.

In another embodiment, the apparatus further comprises a power source that is in electrical contact with the anode and the cathode.

In one embodiment, there is a product that comprises carbon black, wherein the carbon black is made by a method comprising: immersing an anode and a cathode in a molten carbonate electrolyte that includes dissolved CO₂, applying an electric current having a current density of from about 50 mA/cm² to about 10 A/cm² to the cathode and the anode, and forming the carbon black on the cathode.

In another embodiment, the product is one or more of a rubber tire, a rubber hose, or a rubber layer that includes a blend of the carbon black and a rubber.

In another embodiment, the product is an electrostatic coating.

In another embodiment, the product is a pigment or a pigmented coating.

In another embodiment, the product is an abrasion resistant coating.

In another embodiment, the product is an energy storage device.

In another embodiment, the energy storage device is selected from the group consisting of a supercapacitor, an electrochemical cell, or a thermal mass.

### DRAWINGS

Aspects, features, benefits and advantages of the embodiments described herein will be apparent with regard to the following description, appended claims, and accompanying drawings where:

FIG. 1 illustrates one embodiment of an apparatus according to the disclosure.

FIG. 2 illustrates another embodiment of an apparatus according to the disclosure.

### DETAILED DESCRIPTION

This disclosure is not limited to the particular systems, devices and methods described, as these may vary. The terminology used in the description is for the purpose of describing the particular versions or embodiments only, and is not intended to limit the scope.

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. Nothing in this disclosure is to be construed as an admission that the embodiments described in this disclosure are not entitled to antedate such disclosure by virtue of prior invention. As used in this document, the term “comprising” means “including, but not limited to.”

Disclosed herein are methods and apparatus of making carbon black. The methods comprise applying a current across an anode and a cathode while the anode and cathode are immersed in a molten carbonate electrolyte. The inventors surprisingly discovered that in order to produce carbon black rather than other carbon allotropes, a high current density of at least 100 mA/cm² was beneficial. By combining this reactor construction with specified current densities, the reactor during operation would produce solid carbon black particles having a diameter of about 50 nm to about 100 μm in diameter.

The size and shape of the reactor is not limited. The reactor in certain embodiments includes one or more locations for mounting one or more cathodes and one or more anodes. Alternatively, one or more cathodes and one or more anodes can be positioned within the reactor, such as within a reactor chamber. The reactor is a vessel that includes a chamber that is capable of holding molten salt electrolyte at operating temperatures and includes at least one inlet for gas, such as CO₂. The reactor is also connected to at least one source of electrical power, and the electrical power is connected to the one or more cathodes and the one or more anodes.

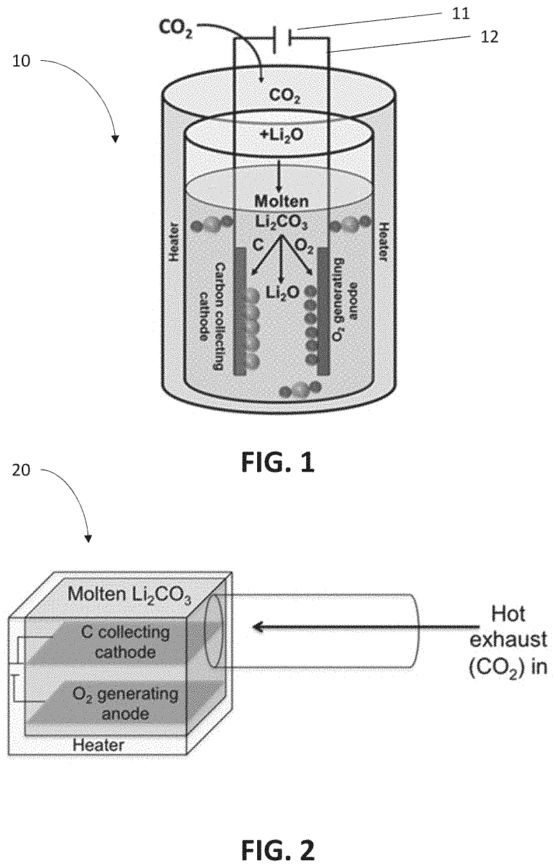

FIG. 1 is one embodiment of an apparatus according to the disclosure. In FIG. 1, CO₂ from one of the sources described herein (exhaust from an industrial process or the fractional distillation of air) is inputted into a chamber of reactor 10. The chamber contains a molten salt electrolyte, such as molten +Li₂O/Li₂CO₃. Positioned within the chamber is a carbon collecting cathode on which carbon black is collected, and an O₂ generating anode which generates O₂ gas. Additional components such as electrical connections 12 to an electrical power source 11 are also included. One or more heaters are also included to maintain the molten salt electrolyte in its liquid form during operation.

The current is applied at a current density sufficient to electrolytically convert CO₂ into carbon and oxygen. In certain examples, the methods described herein can comprise electrolysis of carbon dioxide. The current can, for example, be applied at a current density of 25 mA/cm² or more, 30 mA/cm² or more, 40 mA/cm² or more, 50 mA/cm² or more, 60 mA/cm² or more, 70 mA/cm² or more, 80 mA/cm² or more, 90 mA/cm² or more, 100 mA/cm² or more, 125 mA/cm² or more, 150 mA/cm² or more, 175 mA/cm² or more, 200 mA/cm² or more, 225 mA/cm² or more, 250 mA/cm² or more, 275 mA/cm² or more, 300 mA/cm² or more, 350 mA/cm² or more, 400 mA/cm² or more, 450 mA/cm² or more, 500 mA/cm² or more, 1 A/cm² or more, 5 A/cm² or more, or 7 A/cm² or more. In some examples, the current can be applied at a current density of 10 A/cm² or less, 7 A/cm² or less, 5 A/cm² or less, 3 A/cm² or less, 1 A/cm² or less, 500 mA/cm² or less, 450 mA/cm² or less, 400 mA/cm² or less, 350 mA/cm² or less, 300 mA/cm² or less, 275 mA/cm² or less, 250 mA/cm² or less, 225 mA/cm² or less, 200 mA/cm² or less, 175 mA/cm² or less, 150 mA/cm² or less, 125 mA/cm² or less, 100 mA/cm² or less, 90 mA/cm² or less, 80 mA/cm² or less, 70 mA/cm² or less, 60 mA/cm² or less, 50 mA/cm² or less, 40 mA/cm² or less, or 30 mA/cm² or less. The inventors also contemplate ranges that are formed of two or more of the above endpoints. The current can be applied at a current density that can range from any of the minimum values described above to any of the maximum values described above. For example, the current can be applied at a current density of from 25 mA/cm² to 10 A/cm², from 25 mA/cm² to 250 mA/cm², from 250 mA/cm² to 500 mA/cm², from 25 mA/cm² to 400 mA/cm², from 25 mA/cm² to 300 mA/cm², from 25 mA/cm² to 200 mA/cm², from 25 mA/cm² to 100 mA/cm².

In certain embodiments, the anode or the cathode or both the anode and the cathode include a passivating layer. The passivating layer is coated on a conductive substrate. The conductive substrate can, for example, comprise a metal, a metal oxide, a carbon material, or a combination thereof. Suitable conductive substrates are known in the art.

The passivating layer can, for example, comprise an oxide, a metal nitride, a metal carbide, or combinations thereof. In some examples, the passivating layer can comprise a metal oxide, a metal nitride, a metal carbide, or combinations thereof. The passivating layer can, for example, comprise Al₂O₃, TiO₂, MgO, TiN, VN, or combinations thereof.

The passivating layer can have a thickness of, for example, 2 nm or more (e.g., 3 nm or more, 4 nm or more, 5 nm or more, 6 nm or more, 7 nm or more, 8 nm or more, 9 nm or more, 10 nm or more, 15 nm or more, 20 nm or more, 25 nm or more, 30 nm or more, 35 nm or more, 40 nm or more, 45 nm or more, 50 nm or more, 55 nm or more, 60 nm or more, 65 nm or more, 70 nm or more, 75 nm or more, 80 nm or more, 85 nm or more, or 90 nm or more). In some examples, the passivating layer can have a thickness of 100 nm or less (e.g., 95 nm or less, 90 nm or less, 85 nm or less, 80 nm or less, 75 nm or less, 70 nm or less, 65 nm or less, 60 nm or less, 55 nm or less, 50 nm or less, 45 nm or less, 40 nm or less, 35 nm or less, 30 nm or less, 25 nm or less, 20 nm or less, 15 nm or less, 10 nm or less, 9 nm or less, 8 nm or less, 7 nm or less, 6 nm or less, or 5 nm or less). The thickness of the passivating layer can range from any of the minimum values described above to any of the maximum values described above. For example, the passivating layer can have a thickness of from 2 nm to 100 nm (e.g., from 2 nm to 50 nm, from 50 nm to 100 nm, from 2 nm to 30 nm, from 30 nm to 60 nm, from 60 nm to 100 nm, from 5 nm to 95 nm, from 10 nm to 90 nm, from 20 nm to 80 nm, from 30 nm to 70 nm, from 40 nm to 60 nm, or from 45 nm to 55 nm).

The methods of forming the anode or the cathode are not particularly limited. For example, the passive anode can be formed by depositing the passivating layer on the conductive substrate. The passivating layer can be deposited on the conductive substrate, for example, by thin film processing techniques, such as sputtering, pulsed layer deposition, molecular beam epitaxy, evaporation, atomic layer deposition, chemical vapor deposition (CVD), or combinations thereof. In some examples, the passivating layer is deposited on the conductive substrate by atomic layer deposition (ALD).

In certain embodiments, the passive anode can comprise a metal, a metal oxide, a carbon material, ceramic, or a combination thereof. In some embodiments, the passive anode includes iridium, graphite, platinum, tin oxide, steel, copper, or a combination thereof.

The methods can, in some examples, further comprise heating a metal carbonate to produce the molten carbonate electrolyte. The metal carbonate can, for example, be heated at a temperature of 400° C. or more (e.g., 425° C. or more, 450° C. or more, 475° C. or more, 500° C. or more, 525° C. or more, 550° C. or more, 575° C. or more, 600° C. or more, 625° C. or more, 650° C. or more, 675° C. or more, 700° C. or more, 725° C. or more, 750° C. or more, 775° C. or more, 800° C. or more, or 825° C. or more). In some examples, the metal carbonate can be heated at a temperature of 850° C. or less (e.g., 825° C. or less, 800° C. or less, 775° C. or less, 750° C. or less, 725° C. or less, 700° C. or less, 675° C. or less, 650° C. or less, 625° C. or less, 600° C. or less, 575° C. or less, 550° C. or less, 525° C. or less, 500° C. or less, 475° C. or less, 450° C. or less, or 425° C. or less). The temperature at which the metal carbonate is heated can range from any of the minimum values described above to any of the maximum values described above. For example, the metal carbonate can be heated at a temperature of from 400° C. to 850° C. (e.g., from 400° C. to 625° C., from 625° C. to 850° C., from 400° C. to 800° C., from 500° C. to 800 ° C., from 600° C. to 800° C., from 700° C. to 800° C., or from 725° C. to 775° C.).

The molten carbonate electrolyte can comprise any molten metal carbonate wherein the metal has a higher standard reduction potential compared to carbon. In some examples, the molten carbonate electrolyte can comprise an alkali metal carbonate, an alkaline earth metal carbonate, or a combination thereof. In some examples, the molten carbonate electrolyte can comprise one or more of lithium carbonate, sodium carbonate, potassium carbonate, rubidium carbonate, cesium carbonate, francium carbonate, beryllium carbonate, magnesium carbonate, calcium carbonate, strontium carbonate, barium carbonate, radium carbonate, or a combination thereof. In some examples, the molten carbonate electrolyte comprises lithium carbonate.

In certain advantageous embodiments, the molten carbonate electrolyte comprises two or more different components to form a eutectic mixture. A eutectic mixture is advantageous because it permits operation at lower temperatures than a single, pure or nearly pure molten metal carbonate electrolyte. In some embodiments, the eutectic mixture is a binary eutectic with two different molten carbonate electolytes. In some embodiments, the eutectic mixture is a tertiary eutectic with three different molten carbonate electrolytes.

The CO₂ can, for example, be provided by injecting the CO₂ into the molten carbonate electrolyte. In some examples, injecting the CO₂ into the molten carbonate electrolyte can comprise bubbling the CO₂ from a source into the molten carbonate electrolyte. In some examples, the CO₂ can be provided by contacting the CO₂ with the molten carbonate electrolyte. For example, the molten carbonate electrolyte can be provided in a location such that the atmosphere around the molten carbonate electrolyte comprises the CO₂. The source of the CO₂ that is useful in the present disclosure is not limited, and can be one or more of purified CO₂ (such as obtained by fractional distillation of air), air, exhaust from an industrial process, exhaust from an internal combustion engine, or a combination thereof

The methods can, in some examples, further comprise collecting the carbon black from the cathode. Collecting the carbon black from the cathode can, for example, comprise sonicating the cathode to separate the plurality of carbon black particles from the cathode by dispersing the plurality of carbon black particles into a fluid, such as a solvent or air, and centrifuging or filtering the fluid with the carbon black dispersed therein to thereby collect the carbon black particles. The fluid can be a liquid or a gas, and the solvent can be aqueous, thereby forming an aqueous solution. In some examples, collecting the carbon black from the cathode can comprise mechanically scraping the cathode to separate the carbon black particles from the cathode. In other examples, collecting the carbon black from the cathode can comprise permitting the carbon black to slough from the cathode and fall to the bottom of a reactor chamber. In certain embodiments, collecting the carbon black takes place outside the chamber of the reactor.

In certain embodiments, the carbon black is washed. During washing, the carbon black is contacted with one or more of an acid or water. The acids are not limited and include HCl, HBr, HI, HClO, HClO₂, HClO₃, HClO₄, H₂SO₄, HNO₃, H₃PO₄, acetic acid, citric acid, ascorbic, formic acid, or combinations thereof. In certain other embodiments, the carbon black, which may have also been washed in a previous step, can be dried.

In some embodiments, the methods can further comprise drying the collected carbon black. Drying the carbon black can include heating the collected plurality of collected carbon black particles to a temperature of a temperature of 60° C. or more for an amount of time (e.g., 70° C. or more, 80° C. or more, 90° C. or more, 100° C. or more, 120° C. or more, 140° C. or more, 160° C. or more, or 180° C. or more). In some examples, drying the collected carbon black can comprise heating the collected carbon black to a temperature of 200° C. or less for an amount of time (e.g., 180° C. or less, 160° C. or less, 140° C. or less, 120° C. or less, 100° C. or less, 90° C. or less, 80° C. or less, or 70° C. or less). The temperature at which the collected carbon black particles are heated for drying can range from any of the minimum values described above to any of the maximum values described above. For example, drying the collected carbon black can comprise heating the collected carbon black at a temperature of from 60° C. to 200° C. for an amount of time (e.g., from 60° C. to 120° C., from 120° C. to 200° C., from 60° C. to 90° C., from 90° C. to 120° C., from 120° C. to 150° C., from 150° C. to 180° C., from 180° C. to 200° C., or from 80° C. to 180° C.).

Also described herein are methods of use of the devices for capturing CO₂. For example, the devices can be used to capture CO₂ from the atmosphere (air), exhaust from an industrial process, exhaust from an internal combustion engine, or a combination thereof. In some examples, the methods can further comprise electrolytically converting the captured CO₂ into carbon black. The methods described herein can overcome the drawbacks often associated with carbon capture and conversion/storage by transformation of the captured carbon into a functional material useful for applications in a variety of sectors. One possible application for this technology is the direct integration of this system to an exhaust pipe on a passenger car, which would utilize hot CO₂ exhaust as CO₂ source as well as thermal energy to heat the electrolyte.

FIG. 2 is one embodiment of an apparatus that is used according to the disclosure. In FIG. 2, hot exhaust gas from one of the sources described herein (such as an car exhaust or the exhaust from an industrial process) is inputted into a chamber of reactor 20. The chamber contains a molten salt electrolyte, such as molten +Li₂O/Li₂CO₃. Positioned within the chamber is a carbon collecting cathode on which carbon black is collected, and an O₂ generating anode which generates O₂ gas. Additional components such as electrical connections to an electrical power source (not shown) are also included. One or more heaters are also included to maintain the molten salt electrolyte in its liquid form during operation.

The uses of the carbon black produced according to the disclosure are not limited. The carbon black can be included in one or more of rubber tires, rubber hoses, rubber layers, electrostatic coatings, pigments, pigmented coatings, pigmented layers, abrasion resistant coatings, or energy storage devices. The energy storage device can include one or more of a supercapacitor, an electrochemical cell or a battery of electrochemical cells, or a thermal mass.

In the above detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be used, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions or biological systems, which can, of course, vary. It is also to be understood that the terminology used herein is for the purpose of describing particular embodiments only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” et cetera). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups. It will be further understood by those within the art that if a specific number of an introduced claim recitation is intended, such an intent will be explicitly recited in the claim, and in the absence of such recitation no such intent is present.

For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, et cetera. As a non-limiting example, each range discussed herein can be readily broken down into a lower third, middle third and upper third, et cetera. As will also be understood by one skilled in the art all language such as “up to,” “at least,” and the like include the number recited and refer to ranges that can be subsequently broken down into subranges as discussed above. Finally, as will be understood by one skilled in the art, a range includes each individual member. Thus, for example, a group having 1-3 layers refers to groups having 1, 2, or 3 layers. Similarly, a group having 1-5 layers refers to groups having 1, 2, 3, 4, or 5 layers, and so forth.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

1. A method of making carbon black, the method comprising:
immersing an anode and a cathode in a molten carbonate electrolyte that includes dissolved CO₂,
applying an electric current having a current density of from about 50 mA/cm² to about 10 A/cm² to the cathode and the anode, and
forming the carbon black on the cathode.

2. The method of claim 1, wherein the current density is about 1 A/cm² to about 10 A/cm².

3. The method of claim 1, wherein the cathode comprises a conductive substrate coated with a passivating layer.

4. The method of claim 3, wherein the conductive substrate includes a one or more of metal, a metal oxide, a ceramic, or a carbon material.

5. The method of claim 3, wherein the passivating layer includes one or more of Al₂O₃, TiO₂, MgO, TiN, or VN.

6. The method of claim 3, wherein the passivating layer is about 2 nm to about 100 nm thick.

7. The method of claim 6, wherein the passivating layer is about 45 nm to about 55 nm thick.

8. The method of claim 3, wherein the passivating layer is formed by on the surface of the conductive substrate by one or more of atomic layer deposition (ALD), physical vapor deposition (PVD), or electroplating.

9. The method of claim 1, wherein the anode comprises one or more of a metal, a metal oxide, a ceramic, or a carbon material.

10. The method of claim 9, wherein the anode is a metal and the metal is steel.

11. The method of claim 1, wherein the cathode comprises a one or more of a metal, a metal oxide, a ceramic or a carbon material.

12. The method of claim 11, wherein the cathode is a metal and the metal is steel.

13. The method of claim 1, wherein the molten carbonate electrolyte has a temperature of about 400° C. to about 850° C.

14. The method of claim 1, wherein the molten carbonate electrolyte includes one or more of lithium carbonate, sodium carbonate, potassium carbonate, rubidium carbonate, cesium carbonate, francium carbonate, beryllium carbonate, magnesium carbonate, calcium carbonate, strontium carbonate, barium carbonate, or radium carbonate.

15. The method of claim 14, wherein the molten carbonate electrolyte includes one or more of lithium carbonate, sodium carbonate, or potassium carbonate.

16. The method of claim 15, wherein the molten carbonate electrolyte is a eutectic mixture of two or more of lithium carbonate, sodium carbonate, or potassium carbonate.

17. The method of claim 1, further comprising injecting the CO₂ into the molten carbonate electrolyte.

18. The method of claim 1, wherein the CO₂ is obtained from one or more of air, seawater, exhaust from an industrial process, or exhaust from an internal combustion engine.

19. The method of claim 1, wherein the carbon black has an average particle diameter of about 50 nm to about 100 μm.

20. The method of claim 1, further comprising collecting the carbon black from the cathode.

21. The method of claim 20, wherein collecting the carbon black includes:
immersing the cathode in a fluid,
permitting the carbon black to slough from the cathode so that the carbon black falls to the bottom of the reactor,
collecting the fluid and the carbon black from the bottom of the reactor, and
filtering the fluid, centrifuging the fluid, evaporating the fluid, or applying an electric field to the fluid to separate the carbon black from the fluid.

22. The method of claim 20, wherein collecting the carbon black includes:
immersing the cathode in a fluid,
sonicating or scraping the cathode to separate the carbon black from the cathode and thereby disperse the carbon black into the fluid, and
filtering the fluid, centrifuging the fluid, evaporating the fluid, or applying an electric field to the fluid to separate the carbon black from the fluid.

23. An apparatus for forming carbon black comprising:
a chamber configured to immerse an anode and a cathode in a molten carbonate electrolyte that includes dissolved CO₂;
an inlet for providing CO₂ to be dissolved in the molten carbonate electrolyte, at least one electrical connection that is configured to provide an electric current having a current density of about 100 mA/cm² to about 10 A/cm² to the cathode and the anode, and
an outlet for collecting the carbon black.

24. The apparatus of claim 23, further comprising a power source that is in electrical contact with the anode and the cathode.

25. A product that comprises carbon black, wherein the carbon black is made by a method comprising:
immersing an anode and a cathode in a molten carbonate electrolyte that includes dissolved CO₂,
applying an electric current having a current density of from about 50 mA/cm² to about 10 A/cm² to the cathode and the anode, and
forming the carbon black on the cathode.

26. The product of claim 25, wherein the product is one or more of a rubber tire, a rubber hose, or a rubber layer that includes a blend of the carbon black and a rubber.

27. The product of claim 25, wherein the product is an electrostatic coating.

28. The product of claim 25, wherein the product is a pigment or a pigmented coating.

29. The product of claim 25, wherein the product is an abrasion resistant coating.

30. The product of claim 25, wherein the product is an energy storage device.

31. The product of claim 30, wherein the energy storage device is selected from the group consisting of a supercapacitor, an electrochemical cell, or a thermal mass.
